(19) United States
(12) Patent Application Publication
(10) Pub. No.: US 2006/0091338 A1
(43) Pub. Date: May 4, 2006

(54) Image acquisition system for improved DQE

(76) Inventor: Jacob Koren, Carmelia (IL)

Correspondence Address: Pamela R. Crocker;Patent Legal Staff, Eastman Kodak Company, 343 State Street, Rochester, NY, 14650-2201, US

(21) Appl. No.: 11/260,329

(22) Filed: Oct. 27, 2005

Related U.S. Application Data
(60) Provisional application No. 60/623,332, filed on Oct. 29, 2004.

(51) Int. Cl. G03B 42/08

(52) U.S. Cl. 250/585

(57) ABSTRACT

A method of scanning a sample responsive to stimulating radiation by providing stimulated radiation to the sample along a scanning path that includes more than one pass over at least a portion of the sample. The method includes the steps of performing two read-outs at a particular intensity stimulating radiation. A first read-out of the sample is performed with a the intensity stimulating radiation to produce a first image signal having information representing a first exposure image. A second read-out of the sample is performed with the intensity stimulating radiation to produce a second image signal having information representing a second exposure image. The first and second image signals are then combined to form a third image signal representative of the image stored on the sample.

### CROSS REFERENCE TO RELATED APPLICATIONS

Reference is made to, and priority is claimed from, Provisional Patent Application No. 60,623,332 entitled “IMAGE ACQUISITION METHOD AND APPARATUS FOR IMPROVING DETECTED QUANTUM EFFICIENCY”, filed on Oct. 29, 2004 in the names of Koren, and which is assigned to the assignee of this application.

### FIELD OF THE INVENTION

The invention relates generally to the field of x-ray imaging, and in particular to x-ray imaging using storage phosphor technology. More specifically, the invention relates to an image acquisition apparatus and method for improving detect quantum efficiency.

### BACKGROUND OF THE INVENTION

X-ray imaging technology provides a non-invasive technique for visualizing the internal structure of an object of interest by exposing the object to high energy electromagnetic radiation (i.e., X-rays). X-rays emitted from a radiation source pass through the object and are absorbed at varying levels by the internal structures of the object. As a result, X-ray radiation exiting the object is attenuated according to the various absorption characteristics of the materials which the X-rays encounter.

The absorption characteristics of the object of interest may be captured by placing the object between a high energy electromagnetic radiation source and an image recording medium. As radiation from the source passes through the object, the radiation impinges on the image recording medium with an intensity related to the radiation attenuation caused by the different absorption characteristics of the object. The impinging radiation causes a change in the image recording medium that is proportional to the radiation intensity, thereby storing information about the internal structure of the object. The image recording medium may then be processed to recover the stored information by, for instance, converting it into digital form. Common types of image recording media include sheet film, phosphor media, and the like.

Storage phosphor plate technology has emerged as a valuable image recording media for computed radiography (CR), for example, in medical and dental imaging procedures. When electromagnetic radiation, such as X-ray radiation, impinges on a phosphor plate, the radiation interacts with the phosphor lattice of the plate. The phosphor molecules in the plate store energy proportional to the intensity of the impinging radiation. This energy can later be released by scanning the plate with a laser to excite the phosphor molecules in the plate (i.e., by causing the phosphor molecules to fluoresce). The excited phosphor molecules release radiation that can be detected, quantified, and stored as values representing pixels in an image.

In this manner, a laser scanner and associated electronics, referred to herein as a CR image reader, may convert information stored on a phosphor plate into a digital image of the internal structures of an object being imaged. However, when a laser scanner provides a laser beam to a phosphor plate, the impinging radiation typically does not release all the energy stored in the phosphor plate.

### SUMMARY OF THE INVENTION

The present invention is directed to a method of scanning a sample responsive to stimulating radiation by providing stimulated radiation to the sample along a scanning path that includes more than one pass over at least a portion of the sample.

The present invention is also directed to a method of scanning a sample responsive to stimulating radiation comprising acts of providing a first amount of first radiation to impinge on the sample during a first pass along a predetermined trace, detecting at least some second radiation emitted from the sample in response to the first amount of first radiation provided during the first pass, providing a second amount of first radiation to impinge on the sample during a second pass along the predetermined trace, and detecting at least some second radiation emitted from the sample in response to the second amount of first radiation provided during the second pass.

The present invention includes a scanning apparatus for acquiring an image from a sample responsive to first radiation, the scanning apparatus comprising at least one radiation source adapted to provide first radiation to impinge on the sample when present, at least one detector adapted to receive at least some stimulated radiation emitted from the sample in response to the first radiation, and control means configured to provide the first radiation during a plurality of passes over at least a portion of the sample.

The present invention includes a signal containing image information, the signal comprising a first component based on an amount of stimulated radiation emitted from a sample in response to stimulating radiation provided to impinge on the sample during a first pass along a predetermined trace, and a second component based on an amount of stimulated radiation emitted from the sample in response to stimulating radiation impinging on the sample during a second pass along the predetermined trace.

The present invention includes a scanning apparatus for multi-pass scanning of a phosphor plate, the scanning apparatus comprising a support configured to conformably position the phosphor plate to be scanned, a first pulsed radiation source adapted to alternately be in an on state wherein first radiation impinges on the phosphor plate and an off state wherein the first radiation does not impinge on the phosphor plate, and a second pulsed radiation source adapted to alternately be in an on state wherein second radiation impinges on the phosphor plate and an off state wherein the second radiation does not impinge on the phosphor plate, wherein when the first pulsed radiation source is in the on state, the second pulsed radiation source is in the off state and when the first pulsed radiation source is in the off state, the second pulsed radiation source is in the on state.

The present invention includes a method of multi-pass scanning a phosphor plate comprising acts of providing a first pass by directing a first pulsed laser beam along at least one scan trace of the phosphor plate such that the first pulsed laser beam impinges on the phosphor plate over a plurality of first intervals along the at least one scan trace, and providing a second pass by directing a second pulsed laser beam along at least one scan trace of the phosphor plate such that the second pulsed laser beam impinges on the phosphor plate over a plurality of second intervals along the at least one scan trace, wherein the first plurality of intervals and the second plurality of intervals do not overlap in time.

Any objects provided are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

### BRIEF DESCRIPTION OF THE DRAWINGS

The foregoing and other objects, features, and advantages of the invention will be apparent from the following more particular description of the embodiments of the invention, as illustrated in the accompanying drawings. The elements of the drawings are not necessarily to scale relative to each other.

FIGS. 1A and 1B illustrate a phosphor plate having a substrate and a phosphor layer.

FIG. 2A illustrates exemplary cross-sections of stimulating radiation.

FIG. 2B illustrates a generally Gaussian shape of a cross-sectional area of an intensity profile of a stimulating radiation.

FIG. 2C illustrates a portion of an image recording medium divided into a logical grid.

FIG. 3 illustrates exemplary plots relating to the amount of radiation emitted by the image recording medium in response to a laser beam provided along scan traces.

FIG. 4 illustrates an image acquisition apparatus for scanning an image recording medium that conforms to the inside of a cylindrical surface.

FIG. 5 shows an embodiment of a multi-pass CR image reader according to the present invention.

FIGS. 6A-6C illustrate another embodiment of a multi-pass CR image reader according to the present invention.

FIG. 7A and 7B illustrate further embodiments of multi-pass scanners according to the present invention.

FIG. 8 illustrates one embodiment according to the present invention wherein an excitation or stimulating laser beam is pulsed on and off as it traverses along a scan trace.

FIG. 9 illustrates one embodiment of a pulsed laser beam multi-pass image reader according to the present invention.

### DETAILED DESCRIPTION OF THE INVENTION

The following is a detailed description of the preferred embodiments of the invention, reference being made to the drawings in which the same reference numerals identify the same elements of structure in each of the several figures.

As indicated above, as a laser beam passes over a phosphor plate, not all of the latent energy is released from the imaging plate. A relatively substantial amount of information (in the form of unreleased energy) may remain stored in the phosphor molecules in the plate. The energy remaining in the phosphor molecules is due in part to the laser beam interacting with only a subset of the phosphor molecules and due in part to the characteristics of phosphor excitation and decay.

Accordingly, some number of phosphor molecules retain their stored energy during a first pass of laser excitation. The amount of information that remains latent in the imaging plate affects the signal-to-noise ratio (SNR) of detection signals generated, for example, by one or more photosensitive detector responsive to radiation emitted from the phosphor plate. This reduced SNR ultimately affects the quality of the resulting image.

It has been appreciated that CR images may be improved by providing stimulating radiation (e.g., a laser beam) to a phosphor plate in multiple passes to increase the amount of released energy. For example, U.S. Pat. No. 4,837,436 (whiting), commonly assigned, discloses performing two scans of the image, one at low stimulating intensity to produce a signal A information representing the high exposure range of image detail an one at a high stimulating intensity to produce a signal B having information representing the low exposure range of image detail.

The ability of an X-ray imaging system to transform impinging X-ray radiation into pixel values in an image may be measured by the detected quantum efficiency (DQE) of the system. An increased DQE indicates an increased amount of X-ray radiation that is ultimately accounted for in the pixel intensities of the resulting image.

In general, the DQE of a system can be divided into three main components: 1) the absorption characteristics of a phosphor plate; 2) the efficiency of stimulating and releasing energy from the exposed phosphor plate; and 3) the percentage of the released energy that is collected and detected. Improvements in any of these categories tends to increase the DQE of the system, and hence, the quality, character and/or resolution of the resulting image.

The absorption characteristics of a phosphor plate may include the ability of the phosphor lattice to absorb and store energy from impinging X-ray radiation. For example, the absorption efficiency of a phosphor plate may be related to the extent X-ray radiation (e.g., the X-ray radiation passing through an object being imaged) interacts with phosphor molecules in the lattice as compared to how much X-ray radiation is not absorbed.

The absorption efficiency of a phosphor plate may depend on the type of material comprising the lattice (e.g., the Z-number of the material) and the depth of the material layer.

In general, the material type may be limited to material that both absorb X-ray radiation and release energy upon excitation (e.g., one of various known phosphor materials). Increasing the depth of a phosphor layer generally increases the amount of X-ray radiation that is absorbed by proportionally increasing the likelihood that impinging X-ray radiation will interact with the phosphor lattice.

However, increasing the depth of the phosphor material generally adversely effects the spatial resolution of the resulting image. For example, when an exposed phosphor plate is scanned with a laser beam, increased depths of the phosphor layer increase phosphor-to-phosphor interactions in directions non-parallel to an impinging laser beam (e.g., the point of interaction of the laser beam is effectively expanded). As a general matter, the absorption characteristics of the plate are a manufacturing concern and may be limited by the type, composition and/or arrangement of plates available.

The DQE of a CR imaging system depends in part on how much of the stimulated radiation may be collected and measured. Various collection systems have been designed to direct and channel radiation emitted from a phosphor plate to one or more detectors responsive to the radiation. For example, light guides or pipes may be arranged near the phosphor layer to direct the radiation to the detector. Various arrangements of lenses and reflective surfaces may be employed to channel and direct stimulated radiation towards the detector. For example, a description of an on-axis collection system is included in U.S. Pat. No. 6,624,438 (Koren), entitled “SCANNING APPARATUS,” commonly assigned, and herein incorporated by reference.

The DQE of a CR image reader may depend on how much of the energy stored by a phosphor plate exposed to X-ray radiation may be released. Information may be obtained from an exposed phosphor plate by exciting the phosphor molecules in the plate with electromagnetic radiation, often referred to as stimulating radiation (e.g., a laser beam). The excited phosphor molecules, in turn, release energy as electromagnetic radiation, often referred to as stimulated radiation. Typically, the stimulating radiation and the stimulated radiation are of different frequency.

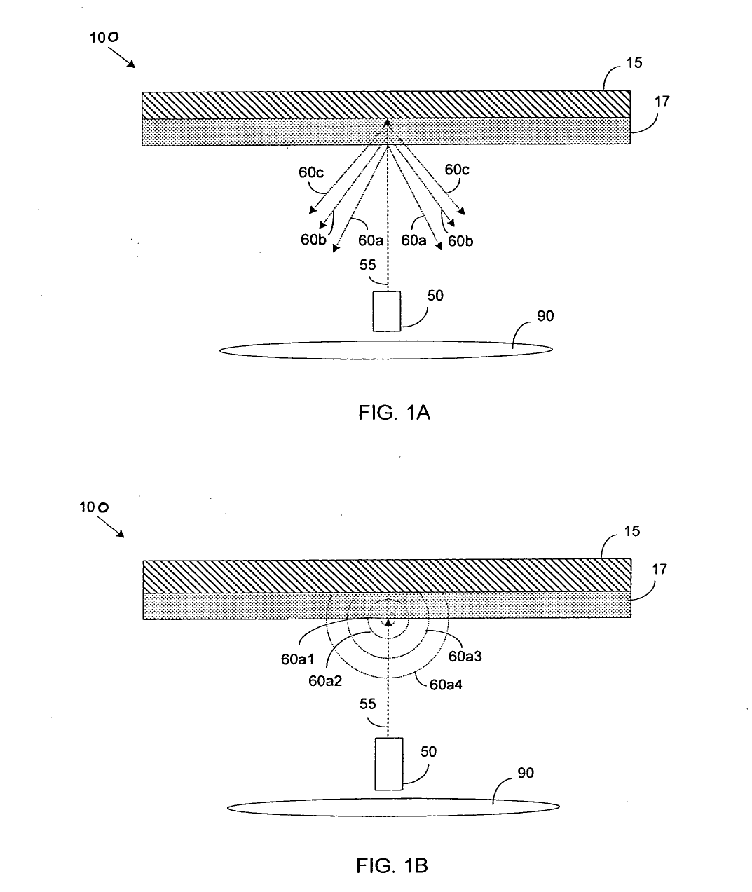

FIGS. 1A and 1B illustrate a phosphor plate 100 comprising a substrate 15 and a phosphor layer 17. The phosphor layer 17 is capable of storing energy absorbed during X-ray exposure, for example, during a medical or dental X-ray imaging procedure. A radiation source 50, such as a laser beam, directs stimulating radiation 55 such that it impinges on the phosphor layer 17 of plate 100. As the stimulating radiation impinges on the phosphor layer, the phosphor molecules are excited and respond by emitting stimulated radiation, illustrated as rays 60a-60c. The stimulating radiation 55 may penetrate phosphor layer 17 and excite phosphor molecules not only on the surface of the layer but also on the interior of the layer as shown by exemplary rays 60b and 60c in FIG. 1A.

It should be appreciated that excited phosphor molecules emit radiation in all directions (the so-called 4π directions) and that rays 60a-60c are merely illustrative. For example, stimulated radiation may emit radiation in all directions as illustrated by the concentric circles 60a1-60a4 emanating from an excited phosphor on the surface of phosphor layer 17 in FIG. 1B. Accordingly, stimulating radiation excites a burst of stimulated radiation, some exemplary rays of which are illustrated in FIGS. 1A and 1B.

Substrate 15 may be made of a reflective material to increase the amount of radiation traveling in a direction towards a detector arranged to collect the stimulated radiation, for example, detector 90. Alternatively, substrate 15 may be made of a material generally transparent to stimulated radiation and a second detector (not shown) may be arranged on the opposite side of plate 100 from the radiation source to detect stimulated radiation emitted from excited phosphor molecules in a direction passing through substrate 15.

Although stimulating radiation 55 is illustrated essentially as a point source, it should be appreciated that stimulating radiation will generally impinge on an image recording medium over a small, finite area.

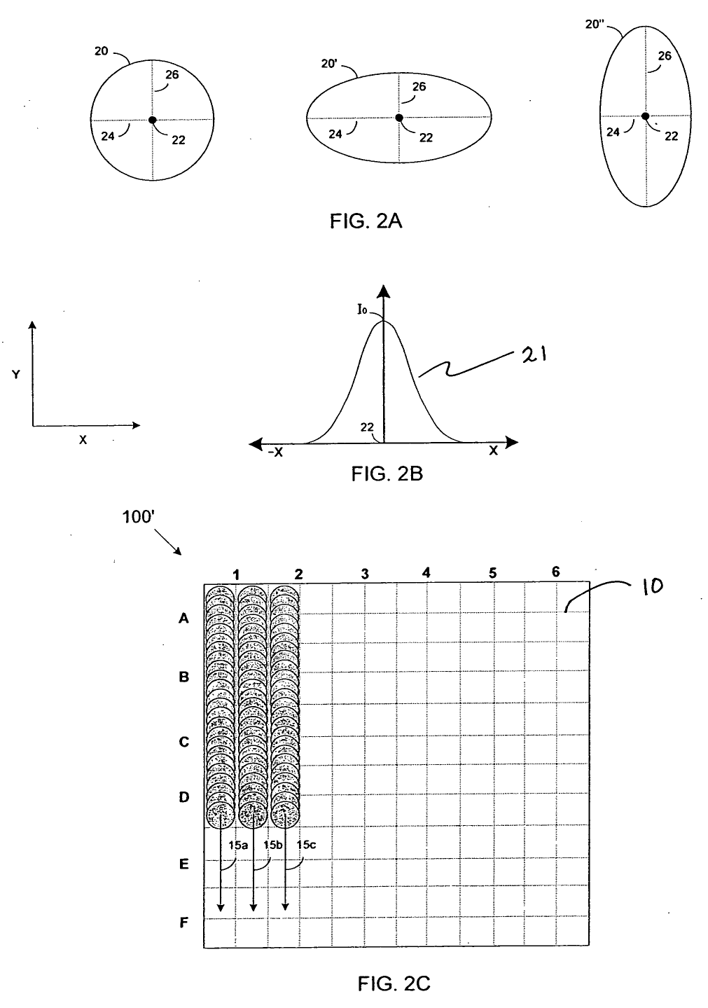

FIG. 2A illustrates exemplary cross-sections of stimulating radiation exhibited by, for example, laser beam radiation sources. A laser beam may be focused such that it forms a cross-section that is generally elliptical in shape, for example, the characteristic shapes illustrated by focal spot 20, 20′ and 20″. A generally elliptical focal spot may be characterized by a center 22, major axis 24, and minor axis 26.

It is noted that the term “focal spot” refers generally to a cross-section or area of radiation emitted from a radiation source wherein the intensity is non-negligible. In particular, the focal spot refers generally to the cross-sectional boundary of radiation at the point of contact with a phosphor medium, wherein the 30 radiation inside the boundary has sufficient intensity to release energy stored in the phosphor molecules in a measurable amount. It should be appreciated that a focal spot may be of any shape and refers generally to the finite area of excitation of stimulating radiation.

The amount of stored energy released from phosphor molecules in a region exposed to stimulating radiation depends in part on the intensity of the stimulating radiation and how long the focal spot impinges on the phosphor molecules, often referred to as dwell time.

The intensity of the stimulating radiation may not be perfectly uniform across its cross-sectional area, for example, the intensity may exhibit a generally Gaussian shape similar to that illustrated in FIG. 2B by intensity profile 21 of focal spot 20′, which decays exponentially from a maximum intensity I₀ at center 22. As a result, radiation impinging on a phosphor plate may decrease in intensity as a function of the radial distance from the center of the focal spot. In response, the phosphor plate will release proportionally fewer photons at locations further away from the center of the focal spot per unit of dwell time.

Information is often obtained from an image recording medium by providing stimulating radiation to the image recording medium in a generally planned path. This process is referred to herein as “scanning”. Laser technology facilitates providing stimulating radiation to a substantially well defined local area by providing control over the characteristics of the focal spot with generally satisfactory precision and accuracy.

An image recording medium can be scanned by varying the position of the focal spot over a pair of axes. By varying the focal spot over a range of a first dimension or along a first axis, a scan line or scan trace may be obtained. The term “scan trace” or “scan line” refers to a predetermined path over a surface of a medium being scanned, and may include line, arcs, helixes or any other appropriate shape that traverses a portion of a medium. Image information obtained from applying radiation along a scan trace typically corresponds to a plurality of pixel intensities over one dimension of the resulting image. For example, image information obtained along a scan trace may correspond to a row or column of pixels in an image. However, some scan traces such as a helix may include image information over more than one dimension.

One method of scanning includes logically dividing an area of an image recording medium into a plurality of pixel regions. Each pixel region may correspond to a pixel in the resulting image. For example, FIG. 2C illustrates a portion of an image recording medium 100′ divided into a logical grid 10 labeled as A-F on the y-axis and 1-6 on the x-axis, the grid forming a plurality of rectangular pixel regions. The pixel width w and pixel length l determine, in part, the resolution of the resulting image.

Generally circular focal spot 20 of a laser beam is shown traversing a portion of image recording medium 100′. The laser beam may be provided such that the focal spot continuously traverses in the y-direction along a scan trace 15a. When the laser beam has traversed over a desired range of the y-axis, the position of the focal spot may be incremented by a distance essentially equal to one pixel width in the x-direction and provided along subsequent scan traces 15b and 15c. It should be appreciated that in FIG. 2C, there is a single laser beam. The successive “snap-shots” merely illustrate the history of the laser beam at discrete times as it traverses the medium in a raster YX direction to illustrate a generally continuous traversal of the medium along the various scan traces.

An image typically represents intensity as a function of space. The term “intensity” refers generally to a magnitude, degree and/or value at some location in the image. For example, in an X-ray image, the pixel intensity generally represents the absorption characteristics of X-ray exposed material at a particular location in space and is typically related to the Z-number or density of the material. An image may be formed by assigning an intensity value to each of the pixel regions logically assigned to an image recording medium by a “superimposed” grid.

For example, an image may be formed via scanning image recording medium 100 by associating an intensity of each pixel in the image with the amount of radiation emitted by the image recording medium over an interval during which the focal spot impinges on and excites phosphor molecules in each respective pixel region. The amount of radiation emitted from the image recording medium in response to stimulating radiation may be measured by providing a detector responsive to the emitted radiation.

Various photosensitive materials responsive to electromagnetic radiation may be suitable for measuring or detecting energy emitted by the image recording medium and providing a corresponding detection signal. For example, a photomultiplier tube may be provided that generates an electrical signal (i.e., a detection signal) proportional to the amount of radiation that is detected. A detection signal may be any signal indicative of an amount of radiation emitted from an image recording medium in response to stimulated radiation. The detection signal typically forms the basis for computing discrete intensities for each of the pixel regions.

As indicated above with reference to FIG. 2C, phosphor plate 100 is scanned with stimulating radiation, for example, a laser. The phosphor plate illustrated in FIG. 2C may be a portion of a larger phosphor plate, for example, having a logical grid associated with an N×M image. Plots 17a, 17b and 17c relate to the amount of radiation emitted by the image recording medium in response to a laser beam provided along scan traces, for example, scan traces 15a, 15b and 15c, respectively. In particular, respective detection signals 19a, 19b, 19c indicate the amount of energy detected by a detector, for example, a photomultiplier tube responsive to radiation emitted from phosphor plate 100 during excitation by the laser beam along scan traces 15a, 15b and 15c, respectively.

Several factors of such an image acquisition of the system may affect the DQE. One factor includes the signal-to-noise ratio (SNR) of detection signals 19a, 19b, 19c. The SNR may be affected by the strength of the “signal” emitted from the phosphor plate (i.e., the magnitude and quantity of radiation released from the phosphor plate), the amount of the emitted radiation that can be collected by the detector, and the levels of noise in the image acquisition process. For example, noise may be due to detection signals carrying ambient radiation or spurious radiation resulting from the decay characteristics of the phosphor molecules, and the like. In addition, noise may result from quantization and discretization noise in converting detection signals into discrete pixel values and other errors that may be associated with the detection and pixelization process.

Accordingly, to increase the SNR of the image acquisition system, either the signal strength must be increased, the noise reduced or a combination of both. The strength of the signal, that is, the portion of a detection signal indicating image information is related to how much energy can be released from the phosphor molecules upon excitation. The amount of energy released by a phosphor plate may be increased by decreasing the speed by which the laser traverses the phosphor plate.

By slowing the traversal speed of the laser beam, the focal spot of the laser beam impinges on each area of the phosphor plate for a longer duration (i.e., the dwell time in each pixel region is increased). Accordingly, the longer the dwell time, the more energy an excited phosphor will release. However, increasing the dwell time of the laser beam increases the scan time of the image reader. Moreover, it should be appreciated that the additional energy released from a phosphor decreases exponentially as a function of dwell time. That is, most of the energy may be released in the first several instants (e.g., during the first or second “time constants” of the decay) such that extending the dwell time of an image reader beyond this may not result in appreciable enough increases in released energy to merit the increase in scan time.

The amount of energy released from a phosphor plate may also be increased by increasing the intensity of the stimulating radiation. For example, increasing the power or flux of the stimulating radiation will increase the amount of the stimulated radiation emitted by the excited phosphor. However, higher power stimulating radiation tends to expand the effective excitation area of the stimulating radiation (e.g., extending the effective focal spot of a laser beam) and adversely affect the spatial resolution of the resulting image.

Applicant has recognized and appreciated that the DQE of an imaging system may be increased by employing more than one pass over an image recording medium. The term “pass” refers generally to a single excitation of phosphor molecules in a region resulting from scanning with stimulating radiation. For example, a pass over a region typically includes an essentially uninterrupted transition from a beginning of exposure to stimulating radiation, an interval of sustained exposure and an end to the exposure. Re-exposure to stimulating radiation involves a second pass over the region. Accordingly, each pass over an image recording medium includes an additional and essentially independent excitation of phosphor molecules in the medium. On each pass, additional stored energy may be released and detected, increasing the DQE of the system.

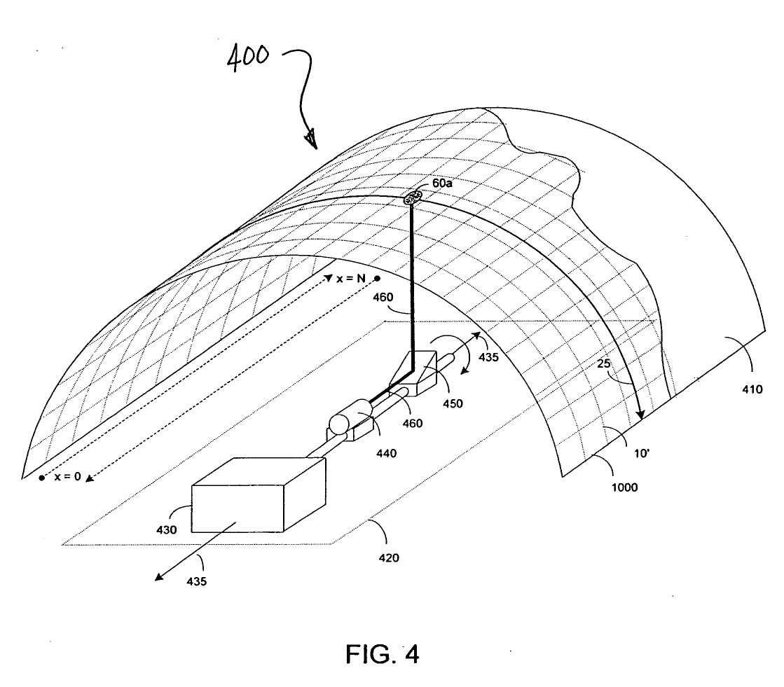

FIG. 4 illustrates an image acquisition apparatus 400 for scanning an image recording medium that conforms to the inside of a cylindrical surface. Scanning apparatus for acquiring images from a cylindrical surface have, inter alia, the generally desirable characteristic that an image recording medium may be traversed using optical equipment adapted to provide radiation with a single degree of translational freedom and a single degree of rotational freedom (e.g., in contrast to two translational degrees of freedom for scanning a planar surface) and may result in simpler and more precise application of stimulating radiation. Image acquisition systems of this nature are described in U.S. Pat. No. 6,291,831 (Koren) which is commonly assigned and incorporated by reference herein in its entirety.

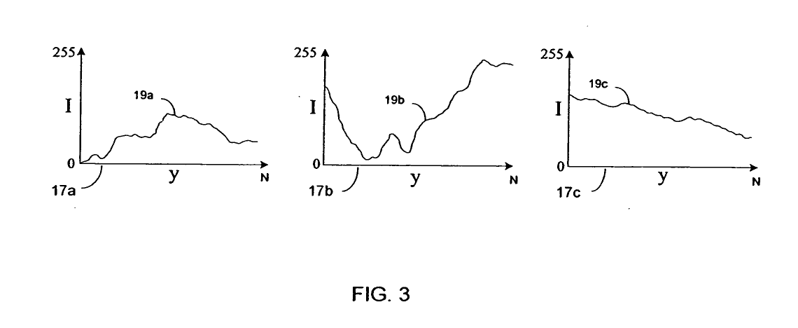

Image acquisition apparatus 400 includes a cylindrical surface 410. An image recording medium, for example, a phosphor plate 1000 having been exposed to X-ray radiation may be mounted on the cylindrical surface 410, for example, by conformally applying the phosphor plate to the inside surface of the cylinder. Phosphor plate 1000 may be similar to the image recording medium described in connection with FIGS. 1-3. The phosphor layer of plate 1000 may be applied to a flexible substrate such that the plate may be conformed to various shapes and surfaces such as cylindrical surface 410, yet return to a substantially flat surface when conforming forces are removed. An optical bench 420 includes a stepper motor 430, a laser source 440 and a reflective surface 450.

The laser source may be adapted to provide a laser beam 460 in a direction essentially parallel to an axis 435 such that it impinges on reflective surface 450. The reflective surface then reflects laser beam 460 off axis 435 such that it impinges on the phosphor plate 1000. For example, reflective surface 450 may be a mirror set at a 45° angle with respect to axis 435 or a pentaprism that directs the laser beam off axis 435 radially outward such that it impinges on phosphor plate 1000. Any surface, component or combination of components capable of directing stimulating radiation to impinge on an image recording medium as desired may be suitable.

Phosphor plate 1000 may be scanned by rotating the reflective surface 450 such that the laser beam impinges in an arc over a range of a first dimension of image recording medium 1000, for example, along scan trace 25. When the beam has traversed a desired arc, the laser beam and reflective surface may be translated one pixel width along axis 435 by the stepper motor and the reflective surface again rotated to provide the laser beam across an arc of the image recording medium along a subsequent scan trace. Alternatively, the cylindrical surface may be incremented one pixel width in an opposite direction along axis 435, while the optical components remain stationary.

In conventional image acquisition systems, a single pass is made of the image recording medium. For example, a first arc may be traced across phosphor plate 1000 at x=0. Subsequent arcs may be traced down the longitudinal axis at increasing values of x until the end of the scan when the last arc has been traced at x=N. However, conventional single-pass scans leave a substantial amount of image information stored in the phosphor plate as latent energy. This information is lost and reduces the DQE of the image acquisition system.

In one embodiment according to the present invention, after a first pass is completed, a second pass is made of the phosphor plate 1000 by tracing successive arcs along the longitudinal axis at decreasing values of x until the end of the second pass is completed when the last arc has been traced at x=0. In this way, each region of phosphor plate 1000 is twice exposed to stimulating radiation. The information obtained from each pass, for example, the detection signals generated by a photomultiplier tube (not shown) arranged to collect stimulated information from each pass may be combined to form the final image. This process may be repeated any number of times to obtain a desired amount of energy stored on the plate. By executing multiple passes, the strength of the detection signal is effectively increased, thus increasing the DQE of the system.

It should be appreciated that only a percentage of the energy stored in the phosphor plate is released on each pass. For example, an exemplary CR reader will release, on average, approximately 30% of the stored energy on a pass. On each successive pass, approximately 30% of the remaining energy may be released. Accordingly, the increase in scan time may not be worth the incremental increase in DQE beyond the first two or three passes. For example, in the situation where one third of the remaining energy is released on each pass, a dual pass system would release 5/9 of the originally stored energy while a triple-pass system would release less than 6/9 of the originally stored energy. The above numbers are merely exemplary of a system that releases approximately one-third of stored energy on each pass.

A sometimes constraining consideration for CR image readers is the time involved in acquiring images from an exposed phosphor plate. This time can be separated generally into scan time and cycle time. Scan time describes the interval beginning when stimulating radiation is first applied to a phosphor plate to obtain stimulated radiation and ending when no more stimulated radiation (i.e., image information) is being collected. For example, in conventional systems, the scan time may be the time required to make a single pass over the phosphor plate. Accordingly, each additional pass increases the scan time.

Cycle time refers generally to the interval beginning when a cassette is loaded into a CR image reader and ending when the phosphor plate has been inserted back into the cassette. A cassette refers to any covering or casing that a phosphor plate can be inserted into and taken out of that protects the phosphor plate from damage such as physical trauma, unintentional exposure to light, and the like.

Cycle time includes acts such as loading the plate from the cassette into the reader, scan time, image formation, erase time, and inserting the plate back into the cassette and ejecting the cassette. In many systems, scan time accounts for less than half of the cycle time. As a result, doubling the scan time (e.g., for a dual pass scan) has relatively small impact on the cycle time.

Applicant has appreciated that the scan time may not be the limiting factor in CR systems. Rather, the cycle time may be the more crucial interval. Accordingly, Applicant has recognized that the increase in scan time resulting from multiple passes is often merited. Ultimately, the most significant time interval from the perspective of a radiologist or technician when considering the work flow of a radiology department is the cycle time. How quickly an exposed plate can be transformed into a viewable image and the CR reader readied for further image acquisition may be considered by some to be more important than how long the CR image reader actually spends applying radiation to the phosphor plate. Accordingly, Applicant has appreciated that the increased DQE resulting from multi-pass scanning may justify the increase in scan time and relatively small increase in cycle time.

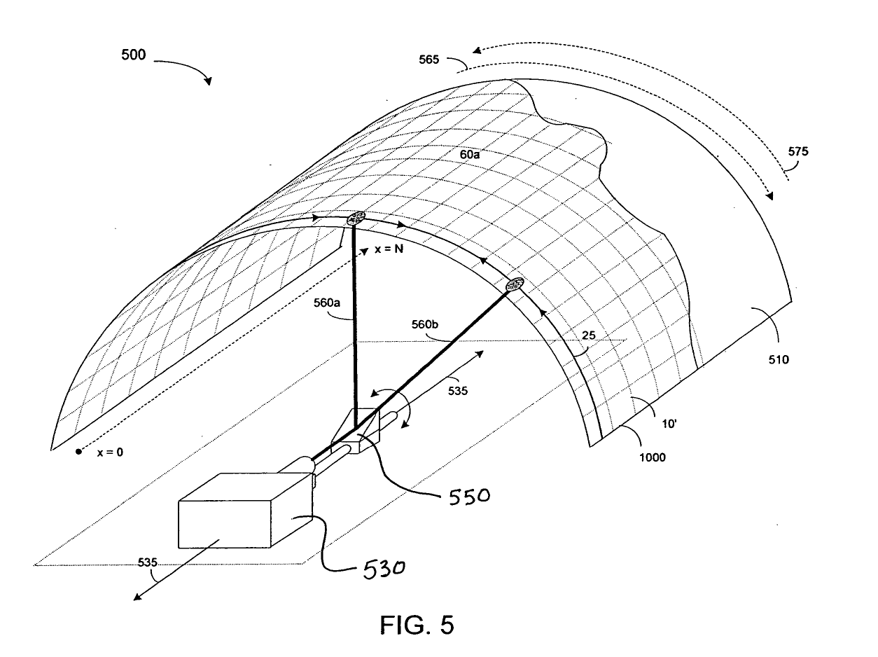

FIG. 5 illustrates another embodiment of a multi-pass CR image reader according to the present invention. CR image reader 500 may be similar to the CR image reader illustrated in FIG. 4. However, CR image reader 500 may accomplish multi-pass scans using a different pattern or scan path. More particularly, instead of traversing a single arc down axis 535 and returning back along the axis tracing a second arc, CR image reader 500 may trace two arcs to produce two scan lines before incrementing a step down axis 535.

For example, the laser beam (e.g., shown in FIG. 5 as laser beam 560a) may be applied in a first arc at x=0 in a direction shown by first pass direction 565. When the arc has been traversed and the scan line fully traced, reflective surface 550 may be caused to rotate in the opposite direction such that the laser beam (e.g., shown in FIG. 5 as laser beam 560b) traverses the same arc again in a direction shown by second pass direction 575. After two passes have been performed along a single scan trace, stepper motor 530 may increment the reflective surface down axis 535 to acquire the next two scan lines by traversing an arc in both the clockwise and counter-clockwise direction. In this manner, a multi-pass scan may be achieved using an alternative scan path. It should be appreciated that any number of arcs can be traversed at any location along axis 535 to result in any desired number of passes.

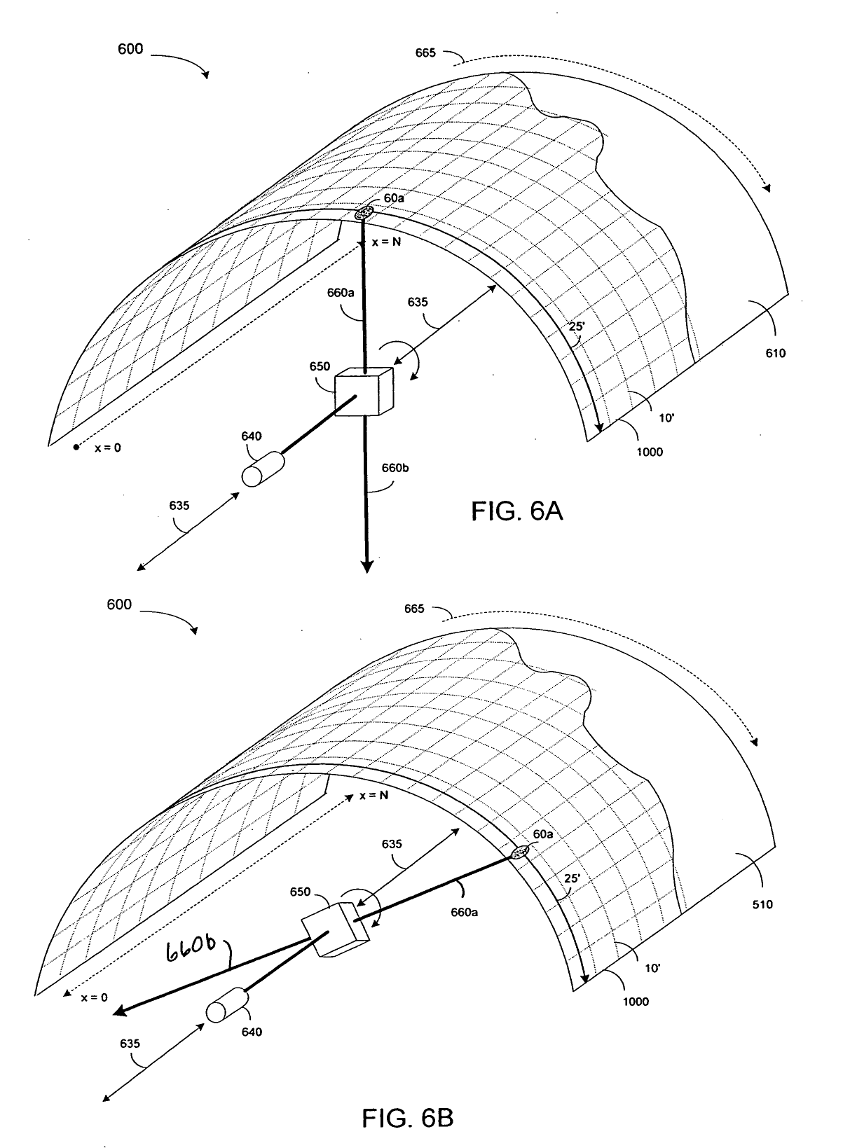

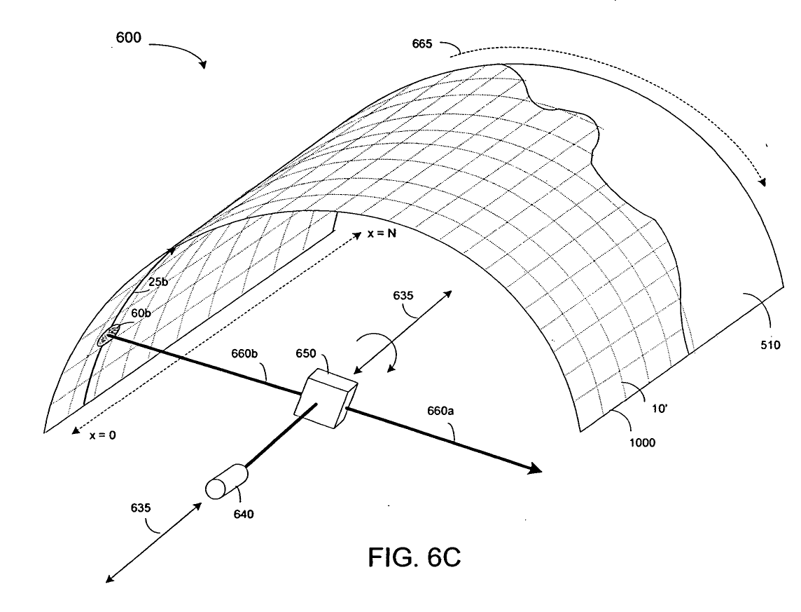

FIGS. 6A-6C illustrate another embodiment of a multi-pass CR image reader according to the present invention. CR image reader 600 may be similar to the CR image readers illustrated in FIGS. 4 and 5. It should be appreciated that any of numerous elements may be arranged such that stimulating radiation may be applied in a generally planned path over the surface of the image recording medium.

In FIGS. 6A-6C, any electrical or mechanical apparatus may be used such that the successive arcs along the axis 635 may be traced over the surface of the phosphor plate 1000. For example, the optical equipment may be translated along axis 635 or the cylindrical segment may be translated along axis 535. Accordingly, various specific apparatus have been removed and it is assumed that some mechanism or combination of mechanisms is provided that allows the phosphor plate to be scanned.

In FIGS. 6A-6C, reflective surfaces shown in FIGS. 4 and 5 (450 and 550, respectively) have been replaced with a beam splitter 650. Beam splitter 650 is arranged such that the laser beam provided by a radiation source 640 is split into two laser beams 660a and 660b, respectively, that are reflected in directions essentially 180° apart from one another. For example in FIG. 6A, when laser beam 660a is in a position to impinge on phosphor plate 1000, laser beam 660b is directed away from phosphor plate 1000 and does not excite any phosphor molecules. As beam splitter 650 is rotated, the laser beams remain at supplementary angles such that only one laser beam is exciting the phosphor molecules at a given time. This can be seen in FIG. 6B. Referring now to FIG. 6C, when beam splitter 650 has rotated such that laser beam 660a no longer impinges on the phosphor, laser beam 660b is in a position to trace over the same arc just traversed by laser beam 660a, causing a portion of the energy remaining in the phosphor molecules after the first pass with laser beam 660a to be released during the second pass. The beam splitter may then be incremented along axis 635 (or alternatively, phosphor plate 1000 or cylindrical surface 610 may be translated) such that a subsequent scan trace may be acquired.

The arrangement illustrated in FIGS. 6A-6C allows the laser beams to be provided continually in a single direction without having to stop and begin rotating various directing apparatus in the opposite direction as described in connection with FIG. 5. In other embodiments, beam splitter 650 is replaced by two reflective surfaces, such as mirrors or pentaprisms arranged to direct radiation at essentially supplementary angles to one another. An additional radiation source may be provided, each radiation source providing a laser beam to a respective reflective surface. The two reflective surfaces may be rotated simultaneously so that only one beam impinges on the phosphor plate at any given time as described above. Other arrangements of optical components may be used to provide more than one laser beam to achieve multiple passes.

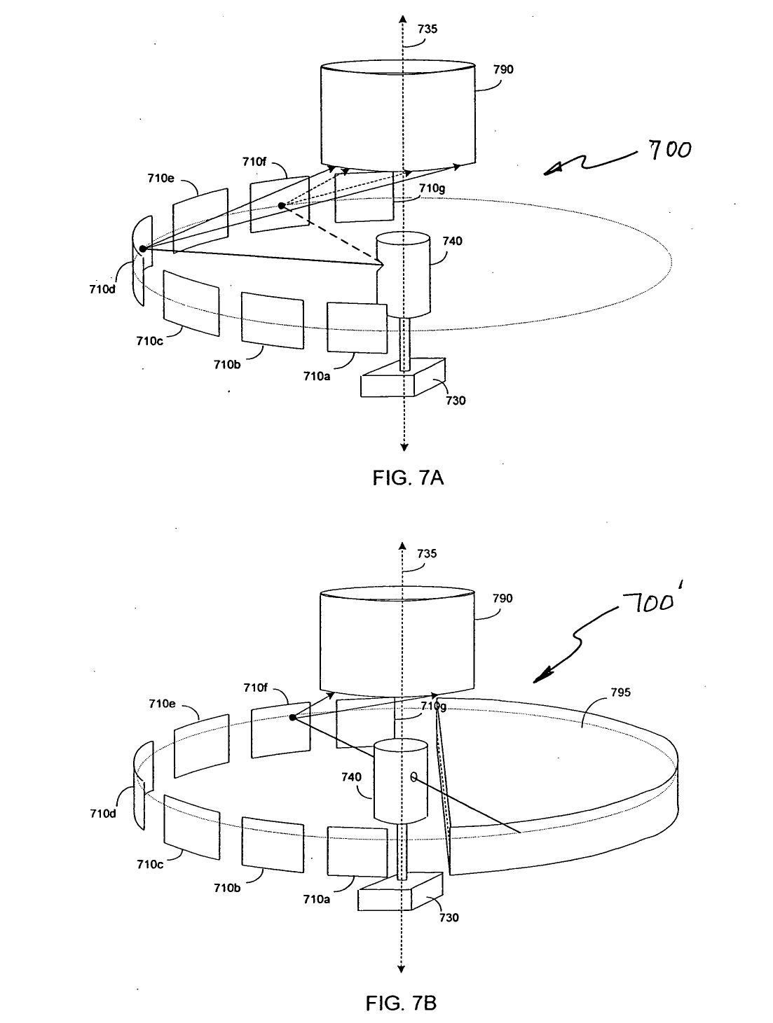

FIGS. 7A and 7B illustrate further embodiments of multi-pass scanners according to the present invention. FIG. 7A illustrates a scanning apparatus 700 adapted to scan one or more phosphor plates, shown in the figure as 710a-710g. For example, phosphor plates 710a-710g may be plates generally used for dental applications, such as oral X-rays. In CR image reader 700, one or more phosphor plates (e.g., phosphor plates 710a-710g) are positioned circumferentially about an optical component 740. Optical component 740 is adapted to provide stimulating radiation in a cylindrical arc such that it impinges on the one or more phosphor plates that are positioned to be scanned. A light collector, such as photomultiplier tube 790, may be provided to detect stimulated radiation emitted from the phosphor plate. A controller 730 is configured to control the scanning path of the stimulating radiation.

It should be appreciated that phosphor plates 710a-710g may be held in place by a support. For example, one or more slots may be provided such that when a phosphor plate is inserted into the slot, the phosphor plate flexes to a generally cylindrical shape and is positioned for scanning. Accordingly, various arrangements may be possible such that a desired surface of the one or more phosphor plates may be scanned. For example, optical component 740 may be adapted to rotate about and translated along axis 735 to provide successive arcs of stimulating radiation to the phosphor plates. Alternately, the radiation source may only rotate about axis 735 and the slots may be adapted such that the phosphor plates are translated along axis 735.

Controller 730 may be adapted to cause optical component 740 to provide stimulating radiation along any desired scan path. For example, optical component 740 may include one or more reflective surfaces that when rotated, direct radiation outward in an arc about axis 735. Controller 730 may control the speed and direction of the rotation of the one or more reflective surfaces. Controller 730 may be a microprocessor capable of executing one or more programs that control optical component 740 along a desired scan path, for example by controlling one or more motors. Optical component 740 may include one or more radiation sources, or any combination of components arranged to provide stimulating radiation to the inserted phosphor plates. Controller 730 may be arranged to control optical component 740 such that stimulating radiation is provided along any number of scanning paths. Specifically, controller 730 may be adapted to provide various multi-pass scans of the one or more phosphor plates that have been inserted into the image reader to be scanned.

In one arrangement, controller 730 may be configured such that stimulating radiation is provided in successive arcs along axis 735 to provide a first pass via a raster scan of the phosphor plates and then to reverse direction along axis 735 and provide successive arcs in the opposite direction along axis 735 to provide a second pass via a raster scan. In another embodiment, at each position along axis 735, controller 730 positions and controls optical component 740 such that stimulating radiation is provided in a clockwise arc to provide a first pass and then a counter-clockwise arc to provide a second pass before incrementing along axis 735 to obtain the next scan trace.

Controller 730 may be configured to reduce an arc length of its scan trace when one or more of the slots are not occupied by a phosphor plate. In addition, controller 730 may be adapted to perform a multi-pass scan on each phosphor plate individually before scanning the next phosphor plate. For example, optical component 740 may be positioned such that stimulating radiation impinges on phosphor plate 710a. The arc length traversed by stimulating radiation for each trace may be limited to the arc length of the phosphor plate and successive arc may be traced along axis 735 until phosphor plate 710a has been fully traversed. When plate 710a is fully scanned, optical component 740 may be positioned such that stimulating radiation impinges on another phosphor plate, such as 710b, if inserted, and the process repeated until all present plates have been multi-pass scanned. Alternatively, the arc length of a scan line may be such that each phosphor plate inserted into the reader is scanned at a particular position along axis 735 before incrementing along the axis. Various other scanning paths will occur to those skilled in the art. However, any scanning path including more than one pass is contemplated and within the scope of the invention.

FIG. 7B illustrates another embodiment of a multi-pass scanner according to the present invention. CR image reader 700′ may be similar to CR image reader 700 and may provide a multi-pass scan similar to that described in connection with FIGS. 6A-6C. For example, optical element 740 may include a beam splitter or may generate two independent laser beams 760a and 760b from independent radiation sources that are directed radially outward from axis 735 at essentially supplementary angles. The relationship between the beams ensures that only a single beam impinges on the phosphor plates at any time. While one of beams 760a and 760b is impinging on the phosphor plates, the supplementary beam is directed into an optical isolation component 795. Optical isolation component 795 may be any structure that absorbs, contains or otherwise prevents the “OFF” laser beam from interfering with the excitation and detection process being performed by the other beam and photomultiplier tube 790.

Alternatively, slots for phosphor plates may be arranged about optical element 740 along the entire circumference. Two independent radiation sources and two detectors may be used that are optically isolated from one another. While one of the radiation sources impinges on phosphor plates arranged in one hemisphere, the other radiation source impinges on phosphor plates arranged in the other hemisphere to perform a first pass of the phosphor plates. As the two beams are rotated 180°, the respective beams impinge on phosphor plates in the other hemisphere to perform a second pass of the phosphor plates. Various other arrangements and scan paths will occur to those skilled in the art. However, any arrangement or scan path providing a multi-pass scan is considered to be within the scope of the invention.

In the foregoing, stimulating radiation has been illustrated as being provided along a scan trace in a generally continuous manner. However, as stimulating radiation, for example, a laser beam continuously traverses a phosphor plate, there are intervals wherein the laser beam appears simultaneously in two adjacent pixel regions of a phosphor plate. As a result, energy is released simultaneously from locations considered logically to be part of separate and distinct pixels. Accordingly, the determination of a particular pixel intensity will be influenced by neighboring pixels. This cross influence has generally undesirable effects on the resolution and quality of the resulting image.

Referring back to FIG. 2C, it is noted that some of the focal spots impinge on portions of more than pixel region simultaneously. As a result, the detector will produce detection signal values having components carrying information from separate pixel regions. This phenomena is described is U.S. Provisional Application Ser. No. 60/531,026, perfected on Dec. 20, 2004 as U.S. Ser. No. 11/018,385 (Koren), commonly assigned, and herein incorporated by reference in its entirety. Also described in the above application is a method of providing a pulsed laser beam along a scan trace such that the laser beam is on only when the focal spot appears within a single pixel region of a logical grid partitioning a phosphor plate.

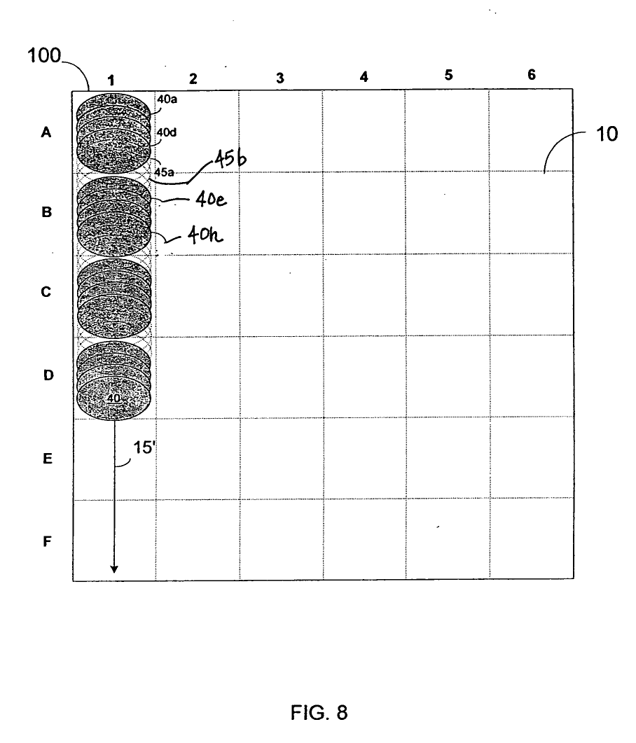

FIG. 8 illustrates one embodiment according to the present invention wherein an excitation or stimulating laser beam is pulsed on and off as it traverses along a scan trace. In FIG. 8, a laser beam may produce a focal spot 40 having a generally elliptical shape with a minor axis that is substantially less than a pixel length of a desired resolution along the scan trace. The major axis may be chosen to be slightly less than a pixel width of a desired or intended resolution such that cross-influence does not occur in directions against the scan trace (i.e., the focal spot does not impinge on more than one column simultaneously when traversed along the scan trace).

When the laser beam is on, the resulting focal spot is illustrated as a solid and filled ellipse, for example, the focal spot at location 40d. When the laser beam is off, a dotted ellipse is shown to indicate the location where the focal spot would impinge if the laser beam were turned on or permitted to impinge on the image recording medium, for example, the phantom focal spot at location 45a.

The laser beam may initially be on at location 40a. The laser may remain on as the beam traverses along trace 15′ until the leading edge of the focal spot reaches the end of pixel region A1, as shown by the focal spot at location 40d. That is, the laser beam may continuously impinge on the image recording medium when the focal spot is located exclusively within a single pixel region. The laser beam may then be pulsed off during intervals wherein the focal spot would simultaneously impinge on more than one pixel region (e.g., phantom focal spots at locations 45a, 45b, and the like). In particular, the laser beam may remain off until the trailing edge of the focal spot passes into pixel region B1. When the laser beam is positioned such that the focal spot will again impinge exclusively in a single pixel region, the laser beam may be pulsed on as indicated by the focal spot at location 40e and may remain on as it traverses across pixel region B1 to a location 40h. This process of pulsing the laser beam may be repeated along the entirety of the scan trace. Each scan trace, in turn, may be acquired by the same method such that image information is obtained from an image recording medium with a pulsed radiation source.

By appropriately choosing the timing of the laser pulses, the scan may be arranged such that the laser is on whenever the focal spot is entirely (or substantially) within a single pixel region and off whenever portions of the focal spot are located in more than one pixel region. As a result, cross-influence may be reduced or entirely eliminated. For example, any arbitrary interval of a detection signal resulting from a pulsed traversal along a scan trace may carry only information from a single pixel region. Accordingly, since each portion of a detection signal may be resolved to a single pixel region, the resolution and quality of the resulting image may be improved.

Pulsed laser beam scanning may be used to facilitate multi-pass scanning that may not substantially increase the scan time. In one embodiment, a pulsed laser beam is provided to the phosphor plate at substantially a 50% duty cycle (e.g., the on and off intervals are of substantially the same duration). A second pulsed laser beam of the same pulsing frequency but of opposing phase may be provided at a desired lag behind the first pulsed laser beam. For example, when the first pulsed laser beam is on, the second pulsed laser beam would be off and vice versa. The first pulsed laser beam performs a first pass of the phosphor plate and the second pulsed laser beam performs a second pass of the phosphor plate. Since the first and second passes are interleaved and not performed one after another, the scan time of a dual pass scan may not significantly increase from the scan time of a single pass scan, if at all.

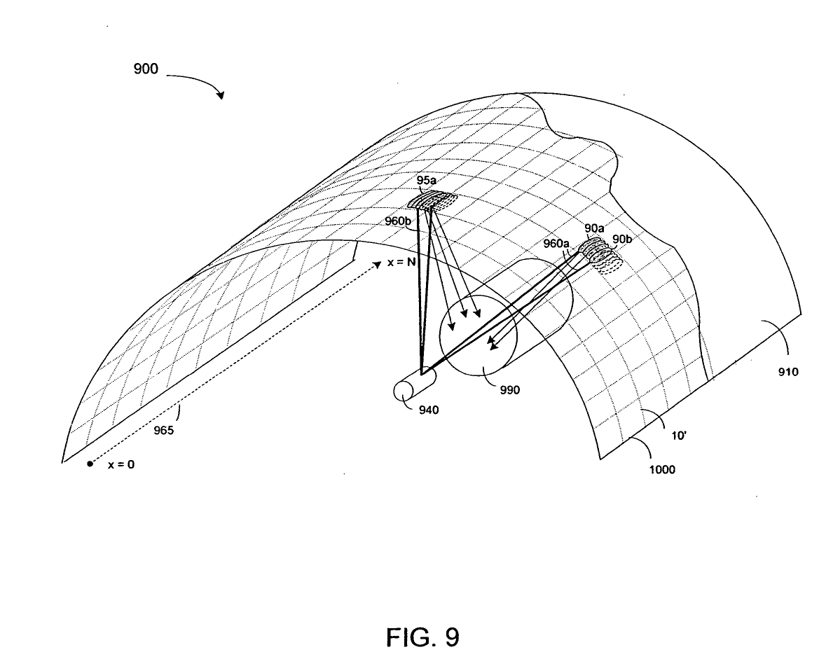

FIG. 9 illustrates one embodiment of a pulsed laser beam multi-pass image reader according to the present invention. The image reader may be substantially similar to the image reader described in FIGS. 4 and 5. It is noted that, since these elements are well known, some portions of an optical bench are not explicitly shown or described so that aspects of the present invention may better be illustrated. CR image reader 900 includes an optical element 940. The optical element 940 represents any of various components and/or combination of components adapted to provide stimulating radiation at desired locations along phosphor plate 1000.

The dual pass scan shown in FIG. 9 is shown during on and off cycles of the two laser beams that are provided by optical component 940. At a first time, laser beam 960a is turned on and impinges on phosphor plate 1000 at focal spot 90a. While laser beam 960a is on and impinging on the phosphor plate, a small arc of substantially the same dimension of a single pixel region is traced out. When the front end of the focal spot reaches the end of the pixel region, as shown by focal spot 90b, laser beam 960a is turned off and laser beam 960b is turned on. Laser beam 960b may be positioned such that it impinges on the phosphor plate at focal spot 95a. While laser beam 960b is on and impinging on the phosphor plate, a small arc over the pixel region is traced out.

During the interval when laser beam 960b is on, laser beam 960a continues to traverse over an arc but does not impinge on the phosphor plate because it is off (i.e., it does not trace the phosphor plate) as shown by the phantom focal spots indicating where laser beam 960a would impinge were it pulsed on. When the front end of focal spot 960b reaches the end of the pixel region, it is pulsed off and laser beam 960a is again pulsed on. Accordingly, while one laser beam is pulsed off to avoid cross-influence stimulation, the second laser beam is in a position entirely within a pixel region and is pulsed on and vice-versa. Accordingly, while the laser beam performing the first pass is pulsed off, a second laser beam may perform a second pass.

Laser beams 960a and 960b may be provided in a number of fashions. For example, the laser beams may be provided by independent radiation sources and directed to the phosphor plate by independent reflection means such as one or more pentaprism, the independent laser sources being toggled on and off appropriately. Alternatively, laser beams 960a and 960b may be generated from the same radiation source and the orientation of one or more reflective surfaces may be controlled in order to provide the laser beams to the correct location on each respective on cycle. In this latter embodiment, the laser beam may never be “off” but rather directed to a first desired location during the on cycle of a scan line of a first pass, and then redirected to a second location during the on cycle of a scan line of a second pass (i.e., the off cycle of the first pass).

In the example illustrated in FIG. 9, laser beam 960b lags behind laser beam 960a by an entire scan trace and an additional approximately 45°. The relationship between the two laser beams is merely exemplary and may be chosen as desired. For example, laser beam 960b may be chosen to trace immediately over the same pixel traversed by laser beam 960a in the previous on cycle. That is, laser beam 960b may lag laser beam 960a by a single pixel. Laser beam 960b may lag laser beam by any number of scan lines or any number of degrees on the same scan line as laser beam 960a. However, the closer the laser beams are to one another, the closer the dual pass scan time will be to a single pass scan time.

The detection signals provided by photomultiplier tube 990 may be processed, for example, by a processor having knowledge of the relationship between the two laser beams. Accordingly, the portions of the detection signals carrying first pass and second pass information for the same pixel region may be combined to form the intensity value for the associated pixel in the resulting image.

Having thus described several illustrative embodiments of the invention, various alterations, modifications, and improvements will readily occur to those skilled in the art. Such alterations, modifications, and improvements are intended to be within the spirit and scope of the invention. While some examples presented herein involve specific combinations of functions or structural elements, it should be understood that those functions and elements may be combined in other ways according to the present invention to accomplish the same or different objectives. In particular, acts, elements and features discussed in connection with one embodiment are not intended to be excluded from a similar or other roles in other embodiments. Accordingly, the foregoing description is by way of example only, and is not intended as limiting. The scope of the invention is indicated by the appended claims, and all changes that come within the meaning and range of equivalents thereof are intended to be embraced therein.

1. A read-out method for a storage phosphor sheet which has been subjected to radiation to form a stored image therein, and the image being read-out by exposure to stimulating radiation to release stimulating radiation in the pattern of the stored image, the method comprising the steps of:
performing a first read-out of the storage phosphor sheet with a first intensity stimulating radiation to produce a first image signal having information representing a first exposure image;
performing a second read-out of the storage phosphor sheet with the first intensity stimulating radiation to produce a second image signal having information representing a second exposure image; and
combining the first and second image signals to form a third image signal representative of the image stored on the storage phosphor sheet.

2. The read-out method of claim 1, wherein the steps of performing the first and second read-out are accomplished by the steps of:
stationarily positioning the storage phosphor sheet;
translating the first intensity stimulating radiation along a length of the storage phosphor sheet from a first end of the sheet to a second end of the sheet while directing the first stimulating radiation across a width of the sheet to produce the first image signal; and
translating the first intensity stimulating radiation along the length of the storage phosphor sheet from the second end of the sheet to the first end of the sheet while directing the first stimulating radiation across a width of the sheet to produce the second image signal.

3. The read-out method of claim 1, wherein the steps of performing the first and second read-out are accomplished by the steps of:
(a) stationarily positioning the storage phosphor sheet;
(b) at a first position, directing the first stimulating radiation in a first widthwise direction across a width of the sheet to produce the first image signal;
(c) at the first position, directing the first stimulating radiation in a second widthwise direction across the width of the sheet to produce the second image signal, the second widthwise direction being opposite the first widthwise direction; and
(d) translating the first intensity stimulating radiation along a length of the storage phosphor sheet to a second position spaced from the first position, and repeating steps (b) and (c) at the second position.

4. The read-out method of claim 3, further comprising the step of repeating step (d) such that the first stimulating radiation is translated along the length of the sheet from a first end of the sheet to a second end of the sheet.

5. The read-out method of claim 1, wherein the steps of performing the first and second read-out are accomplished by the steps of:
directing the stimulating radiation along an axis directed along a length of the sheet toward a rotating beam splitter which produces two essentially opposing stimulating radiation beams;
performing a first read-out of the storage phosphor sheet when one of the stimulating radiation beams impinges the sheet to produce a first image signal having information representing a first exposure image; and
performing a second read-out of the storage phosphor sheet when the other of the stimulating radiation beams impinges the sheet to produce a second image signal having information representing a second exposure image.

6. The read-out method of claim 5, wherein the other of the stimulating radiation beams impinges an optical isolation device when the one of the stimulating radiation beams impinges the sheet.

7. The read-out method of claim 5, further comprising the step of translating the rotating beam splitter along the length of the sheet from a first end of the sheet to a second end of the sheet.

8. A read-out method for a storage phosphor sheet which has been subjected to radiation to form a stored image therein, and the image being read-out by exposure to stimulating radiation to release stimulating radiation in the pattern of the stored image, the method comprising the steps of:
stationarily positioning the storage phosphor sheet;
providing two essentially opposing stimulating radiation beams;
performing a first read-out of the storage phosphor sheet when one of the stimulating radiation beams impinges the sheet to produce a first image signal having information representing a first exposure image;
performing a second read-out of the storage phosphor sheet when the other of the stimulating radiation beams impinges the sheet to produce a second image signal having information representing a second exposure image; and
combining the first and second image signals to form a third image signal representative of the image stored on the storage phosphor sheet.

9. The read-out method of claim 8, wherein the step of providing two essentially opposing stimulating radiation beams is accomplished by directing the stimulating radiation along an axis directed along a length of the sheet toward a rotating beam splitter which produces two essentially opposing stimulating radiation beams.

10. The read-out method of claim 8, further comprising the step of, while directing the stimulating radiation, translating the rotating beam splitter along the axis from one end of the sheet to an other end of the sheet.

11. The read-out method of claim 8, wherein the other of the stimulating radiation beams impinges an optical isolation device when the one of the stimulating radiation beams impinges the sheet.

12. A read-out apparatus for a storage phosphor sheet which has been subjected to radiation to form a stored image therein, and the image being read-out by exposure to stimulating radiation to release stimulating radiation in the pattern of the stored image, comprising:
positioning means for stationarily positioning the storage phosphor sheet;
a radiation source emitting stimulating radiation along an axis directed along the length of the sheet;
a beam splitter disposed along the axis which produces two essentially opposing stimulating radiation beams;
means for rotating the beam splitter such that either one or the other of the stimulating radiation beams impinges the sheet at a particular time wherein (1) a first read-out of the sheet is performed when one of the stimulating radiation beams impinges the sheet to produce a first image signal having information representing a first exposure image, and (2) a second read-out of the sheet is performed when the other of the stimulating radiation beams impinges the sheet to produce a second image signal having information representing a second exposure image; and
means for combining the first and second image signals to form a third image signal representative of the image stored on the storage phosphor sheet.

13. The read-out apparatus of claim 12, further comprising an optical isolation device wherein the other of the stimulating radiation beams impinges the optical isolation device when the one of the stimulating radiation beams impinges the sheet.

14. A read-out method for a storage phosphor sheet which has been subjected to radiation to form a stored image therein, and the image being read-out by exposure to stimulating radiation to release stimulating radiation in the pattern of the stored image, the method comprising the steps of:
stationarily positioning the storage phosphor sheet;
providing two stimulating radiation beams;
activating one of the stimulating radiation beams to perform a first read-out of the storage phosphor sheet when the one of the stimulating radiation beams impinges the sheet to produce a first image signal having information representing a first exposure image;
deactivating the other of the stimulating radiation beams when the one of the stimulating radiation beams is activated;
activating the other of the stimulating radiation beams to perform a second read-out of the storage phosphor sheet when the other of the stimulating radiation beams impinges the sheet to produce a second image signal having information representing a second exposure image;
deactivating the one of the stimulating radiation beams when the other of the stimulating radiation beams is activated; and
combining the first and second image signals to form a third image signal representative of the image stored on the storage phosphor sheet.

15. The read-out method of claim 14, wherein the step of providing two stimulating radiation beams is accomplished by directing the stimulating radiation along an axis directed along a length of the sheet toward a rotating beam splitter which produces the two stimulating radiation beams.

16. The read-out method of claim 15, further comprising the step of translating the rotating beam splitter along the length of the sheet from a first end of the sheet to a second end of the sheet.
